(19) United States
(12) Patent Application Publication
(10) Pub. No.: US 2003/0014333 A1
(43) Pub. Date: Jan. 16, 2003

(54) Portable audio device and network including an audio device

(76) Inventor: Barry Allen Thomas Brown, Glasgow (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/172,501

(22) Filed: Jun. 17, 2002

(30) Foreign Application Priority Data
Jun. 19, 2001 (GB) 0114904.6

(51) Int. Cl. G06F 17/60

(52) U.S. Cl. 705/28; 705/22

(57) ABSTRACT

A network has first and second audio data storage devices, each including a memory area storing one or more audio data files. A file selector enables a user to select at least one stored audio data file. A data processor accesses the selected files from the memory and processes the selected files with a profile to generate a processed audio signal. The first device communicates across the network to the second device so any data files in the first device memory which are not present in the second device are automatically copied to the second device memory.

This invention relates to an improved portable audio device and to apparatus for use therewith. It in particular relates to a portable audio device which provides for easy storage, replay and updating of audio data stored in the device.

In this specification the term audio data is to be interpreted broadly. It covers not only stored data encoding an audio signal but also data which directs a device or a user to the source of an audio signal. An example of this latter arrangement is a web address which indicates the location of an audio signal on a remote network element such as a web page accessible over the internet. The audio data need not necessarily comprise an audio signal but merely a signpost to the location of an audio signal which a device can access when a user wants to play the audio signal.

The popularity of music with people of all ages is showing no signs of decreasing. In addition to the bulky home entertainment systems that are present in almost every household, recent developments in data storage have seen considerable advances in portable audio reproduction devices.

The Sony Walkman—which allowed sounds recorded as analogue signals on an audio cassette to be reproduced—is perhaps the earliest example of a successful portable audio device. Prior to the Walkman the only way of hearing recorded music on the move was the portable radio or a bulky cassette player. In recent years, the compact disk has replaced the audio cassette due to the improved quality of the audio reproduction that can be achieved.

Compact disks can hold a large amount of data but devices which use these disks are relatively bulky. An improvement would be to store the data in a non-volatile memory but until recently the cost of the memory has made such a device unrealistic. A drop in the cost of electronic memory, and the development of standards for electronic data compression techniques—permitting many minutes of high quality audio data to be stored in a relatively small area of electronic memory—has made these devices a commercial reality.

The most popular format for audio data storage in current use is the MP3 format in which a stream of digital audio information is compressed prior to storage. When the device plays back such a file the data is decompressed on the fly to produce the original data stream (or a close approximation of the original audio data) which can be passed to a D/A converter and subsequently reproduced through a pair of earphones.

Even a compressed data file requires a relatively large amount of memory and until recently portable devices have been limited to the storage of around 1 or 2 hours of musical data. In recent years, increases in the amount of memory in devices have spiralled. In some cases, portable devices have been provided with hard drives for data storage which can easily hold the equivalent of around 150 albums (3 Gigabytes of MP3 data files). The user can in effect store an entire record collection on these larger capacity portable devices.

As the amount of data increases, the shortcomings with existing interfaces between the device and the source of the original data have become more apparent. Typically, a user will purchase an item of music, such as a CD, from a record store which is loaded onto and copied to their computer. The computer converts the data on the CD to a compressed format. Alternatively, the user may purchase the music across a network, such as the internet. In either case, the user must connect a cable from the portable device to the computer and instruct the computer to copy a selected file to the memory of the portable device. This is at best inconvenient as it is both time consuming and requires a degree of computer literacy which is off putting to many older consumers.

An object of the present invention is to provide a portable audio device (or music player) which overcomes the shortcomings described hereinbefore.

A further object is to provide apparatus, such as a network, for use in combination with a portable device that simplifies the transfer of data to the portable device.

In accordance with a first aspect the invention provides a network comprising a first and a second audio data storage device, each device comprising:

an area of memory in which one or more audio data files are stored,

a file selection means adapted to permit a user to select one or more of the stored audio data files, and

a data processor adapted to access the one or more selected files from the memory to generate an audio signal;

in which the first device is adapted to communicate across the network to the second device such that data files stored in the memory of the first device which are not present in the second device are automatically copied to the memory of the second device.

By automatically we may mean that the copying of data is initiated automatically without human intervention whenever one of the devices detects the presence of the other device in the network. It most preferably initiates copying when a device is detected as joining a network.

One of the devices preferably comprises a portable music player. By portable we mean a handheld device which may conveniently be carried in a pocket of a jacket or shirt and which will typically be battery operated.

The other device may be another portable device or may be any one of: a personal computer, a mini-disc player, and MP3 player, a compact disk player.

Where the first device comprises a compact disk player it may be adapted to store in its memory data files corresponding to the audio data stored on a compact disk played on the device. It may create and store these files every time a disk is played to build up a database of a users CD collection over time as the CDs are played. This may occur automatically.

The portable device may include transmission means adapted to transmit an identity signal across the network, and the other device may be adapted to issue an acknowledgement signal to the portable device in response to the detection of an identifying signal. Of course, the devices may operate in the opposite manner with the remote device issuing the identifying signal and the portable device acknowledging the signal.

The or each, or at least one of the portable and other devices may include an inventory generation means adapted to generate an inventory of the audio files stored in the memory of the device. This may identify all of the audio data files in the memory of the device or a subset of the audio files. By audio data file it will be understood that we mean any identifiable item of audio data that can be stored in the memory, such as an MP3 type file. The device issuing the identifying signal may transmit its inventory as part of the identifying signal to the other device. Alternatively, it may be transmitted as part of the acknowledging signal.

In both instances, upon receiving an inventory the receiving device may be adapted to compare the received inventory with its own inventory. An update inventory may be generated which comprises a list of audio files stored on the first device that are not present on the second device.

Each of the devices in the network may include a wireless network connection for communication with the other device. The first device does not, therefore need to be physically connected to the second device. For example, a user of a portable device may simply place it next to a computer or other suitable device to start the data update.

The wireless connection may be compatible with the Blue-Tooth wireless convention for data communication. Alternatively, an infrared connection may be provided.

One or more of the devices may include reproduction means for reproducing audibly the audio information stored in the processed audio signal. This may be an integral part of the device or may be removably connected to the device. It may, in the case of a portable device comprise a pair of stereo headphones. In the case of a personal computer it may comprise a sound card which generates an analogue audio signal from the audio data which can be played through a set of loudspeakers or perhaps headphones.

The device to which data files are to be transferred may include means for checking the legality of the data transfer. Alternatively, the device transmitting the data file may be adapted to only do so if the transfer is legal. One or more of the devices may therefore include means for checking the legality of the transfer, and means for preventing the data being copied if it is illegal.

For instance, a data file may include a rights identifier indicating the identify of users who can copy the data. Alternatively, the data file may direct the device to check a remote data store, such as a web page on a remote server, to check the legality of the transfer of data.

As an example, when a user first stores a data file on a device, the user may only be permitted to copy the data to other devices which they own, or may only make a limited number of copies. The checking means may be adapted to check the identity of the user of a device, or check how many copies have been made previously.

In accordance with a second aspect the invention provides an audio device configured to operate as a first or a second device within a network according to the first aspect of the invention.

The audio device may be any one of the following: a portable audio device; a personal computer, a mini-disc player, and MP3 player, a compact disk player. This is not intended to be an exhaustive list of devices within the scope of this aspect of the present invention.

In accordance with a third aspect the invention provides a data carrier which includes a computer programme which when running on a processor of a device causes the device to operate as a first or a second device within a network according to the first aspect of the invention.

In accordance with a fourth aspect, the invention provides a method of operating a computer system comprising at least a first and a second audio data storage device connected to form a network, the method comprising:

storing one or more audio files in a memory of at least one of the devices;

causing the first device to communicate across the network to the second device;

comparing the audio data files stored in the first device with the audio data files stored in the second device; and

automatically copying audio data files which are stored in the first device and which are not stored in the second device across to the second device.

By comparing the data files the audio may mean comparing the title of a data file or comparing the data stored in a data file.

The method may further comprise causing the first device to access an inventory of audio data files stored in the second device across the network and compare the inventory with a corresponding inventory of data files stored in the first device.

Alternatively, the first device may transmit an inventory of its stored data files to the second device which subsequently compares the transmitted inventory with its own inventory to identify data files stored in the first device that are not stored in the second device, and the second device subsequently transmitting to the first device across the network a request list of data files which are stored in the first device but not in the second device.

The method may further comprise preventing the automatic transfer of one or more data files if the transfer is illegal.

At least one data file may include a rights identifier, or may indicate the location of a rights identifier, and each device transmitting data, and/or each device receiving data, may check the rights identifier to determine if a transfer is permitted.

The method may comprise issuing a warning in the event that a user of a device attempts to copy data which cannot legally be copied.

According to a fifth aspect of the invention, there is provided a portable audio data storage device comprising:

an area of memory in which one or more audio data files are stored;

a file selection means adapted to permit a user to select one or more of the stored audio data files; and

a data processor adapted to access the one or more selected files from the memory to generate an audio signal;

in which the device is adapted to communicate to at least one other device across a network such that data files store in the memory of the at least one other device on the network that are not present on the audio data storage device are automatically copied to the memory of the audio data storage device.

Additionally, the device may be adapted to copy across the network audio data files which are not stored in the memory of the at least one other device to the at least one other device.

At least one of the at least one other devices may be a Personal Computer.

The or each audio file may be an encoded music track.

A plurality of audio data files may be stored in the memory of the device, the plurality of audio data files forming a music collection.

The device may be an MP3 player.

The network may be a wireless network and the device may further comprise a wireless network transceiver. The wireless network may be a Bluetooth network.

The copying of audio data files may occur automatically with no user intervention.

There will now be described by way of example one embodiment of the present invention with reference to the accompanying drawings of which:

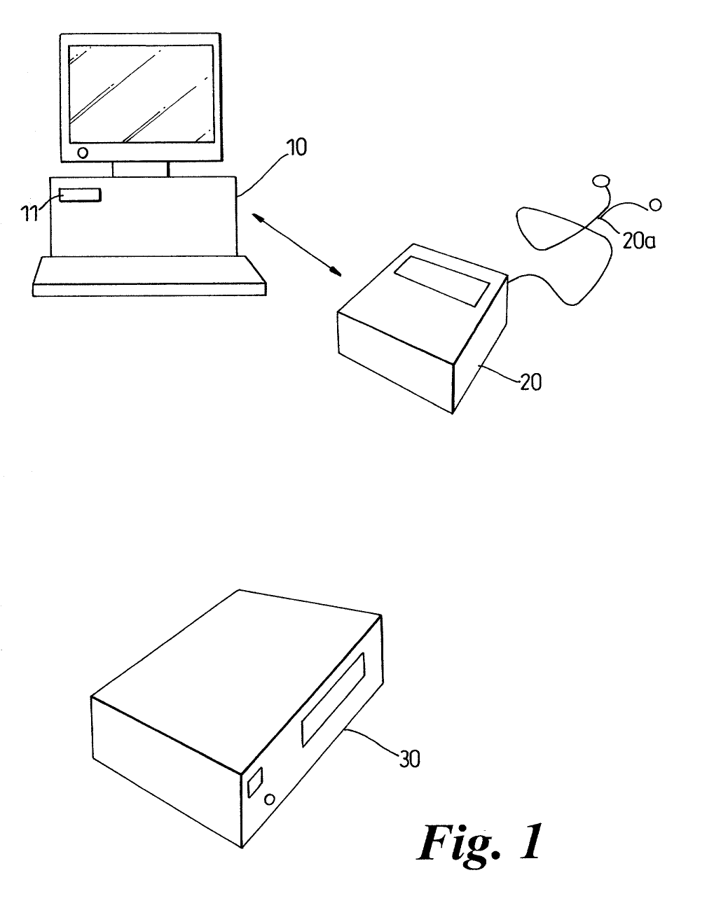

FIG. 1 is an overview of three devices in accordance with the second aspect of the invention partially connected to form a network in accordance with the first aspect of the invention;

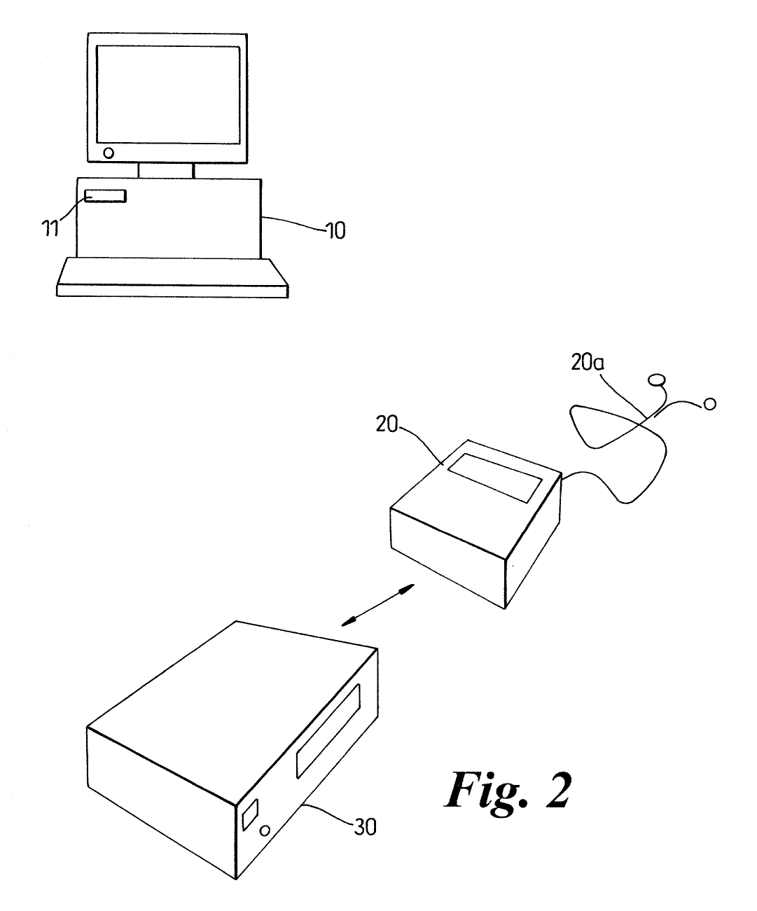

FIG. 2 is a schematic illustration of the same three devices as FIG. 1 which are connected to form a different network in accordance with the invention;

FIG. 3 is an enlarged perspective view of the portable device shown in FIGS. 1 and 2; and

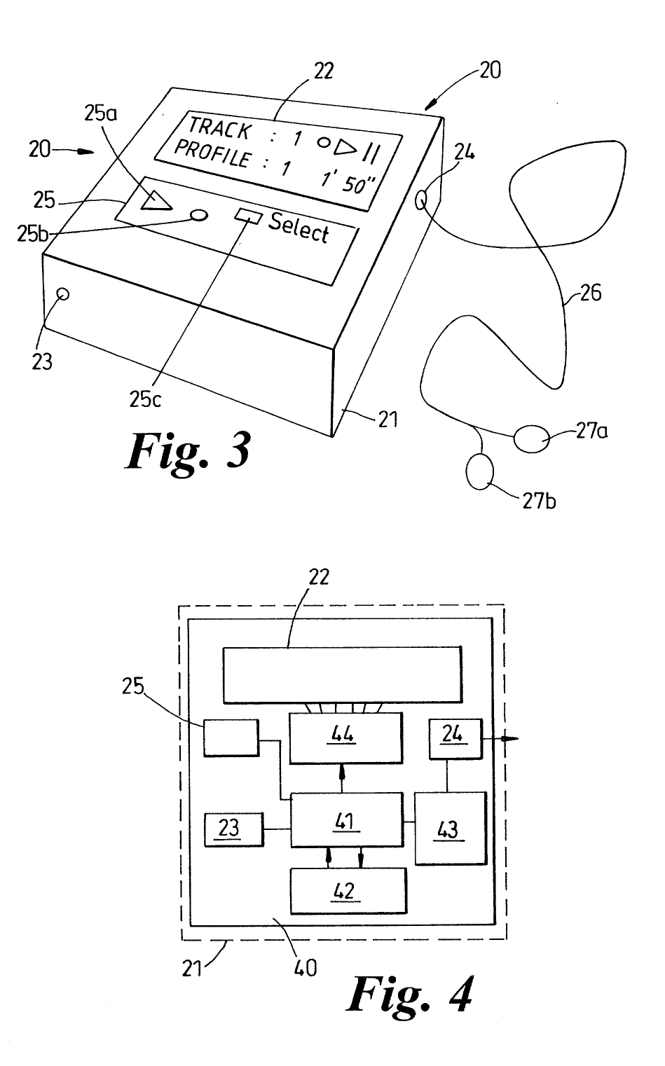

FIG. 4 is a schematic illustration of the components of the remote network device illustrated in FIG. 1.

The network shown in FIG. 1 includes at least two devices 10,20 which each are connected across a wireless network connection. A third device 30 is also shown in FIG. 1. The third device in this arrangement does not form part of the network as it is too far away from the other two devices 10,20.

At least one of the devices 20 is a portable device and in this example comprises a pocket sized music player which is provided with a pair of headphones 20a through which music stored on the device can be replayed. The other of the devices may also comprise a portable device. However, in the example illustrated in FIG. 1 of the accompanying drawings this device comprises a desktop computer 10. It may be assumed that the computer and the portable device belong to the same person. In practice this need not be the case.

The portable device 20 can communicate with the personal computer 10 since it is within the range of the wireless communication link. However, it will be appreciated that as the portable device is moved around by the user the members of the network will change. As shown in FIG. 2 the portable device 20 has been moved away from the computer 10 and into the range of the third device 30. In this example the third device 30 comprises a compact disk player which is wireless network enabled. The portable device is now out of range of the computer and the portable device and the compact disk player now define a new network.

In use, the user may purchase music as compact disk recordings. These can be played on the compact disk player and listened to as normal. Also, the personal computer includes a compact disk drive 11 and the user can listen to the purchased music through speakers (not shown) connected to the computer.

In an alternative, the user can purchase music over the internet by connecting the PC to the internet using a modem (not shown). This allows music to be downloaded to the computer for subsequent playback.

The portable device is illustrated in perspective view in FIG. 3 of the accompanying drawings. The device comprises a rectangular body 21 which includes a liquid crystal display panel 22, a wireless input port 23, and output socket 24 and a plurality of user operated selection buttons 25 provided in a group on the front face of the housing. The wireless input port 23 shown is of the infra-red type and is adapted to receive data from an infra-red emitter for passing audio information to the device. The output socket 24 comprises a jack socket for receiving a stereo plug which is provided on a lead 26 extending from a pair of stereo headphones 27a, 27b. The buttons 25 permit a user to select a piece of audio data-such as a musical track-from a range of samples stored in the device 20. The input buttons 25 include a play button 25a to start the device playing the selected sample, a stop button 25b to stop the device playing, and a sample selection button 25c that allows the user to select from the samples held in the device. The display 22 allows the user to see which sample has been selected and may also displays information about the sample such as the artist, the title, the sample run time etc.

Of course, other buttons (not shown) may be provided such as a volume control, skip track/previous sample etc as is well known.

Referring now to FIG. 4 of the accompanying drawings, the housing 21 of the device 20 contains a printed circuit board 40 which interconnects each of the input buttons 25, the display 22, a wireless infra-red port 23 and the output socket 24 to an electronic circuit. The circuit includes a processor 41 and an area of electronic memory 42 which contains programme instructions that run on the processor when the device is operating and also permit data supplied to the input port 23 to be stored in the memory 42 on the device 20. The data is stored as data files within the memory 42. Each data file contains the audio information required to reproduce an audio sample and may also include additional information about the sample such as its length, title and so on. The data in the files is compressed to minimise the amount of memory required. A battery 23 within the housing drives the electronic circuit.

The processor 41 receives input signals from the input buttons 25 and the input port 23. In turn, the processor 41 generates an output signal which is fed to a digital to analogue converter 43 that derives the headphone socket. In practice, two D/A converters are used to generate each of the two analogue channels of a stereo signal. The processor 41 also produces output signals which are passed to a display driver 44 that drives the display 12.

In use, the processor 41 accesses one of the data files stored in the memory 42 in response to a user input. The accessed file is decompressed by the processor 41 to produce a digital data stream which is fed to the input of the digital to analogue converter 43. The output of the analogue to digital converter 43 is an analogue audio signal that is fed to the headphones 27a, 27b. The user can then listen to the reproduced audio sample that he or she has selected.

The processor also generates an inventory of the audio data files stored in the memory. This inventory is also stored in the memory and is updated whenever new files are added to the memory or are deleted from the memory of the device.

In addition to permitting the user to replay selected audio files from the memory the device communicates with any other devices within range of the device. The processor transmits signals from the wireless port to any devices within range. If a device is within range (such as the computer in FIG. 1 or the CD player in FIG. 2), they send back a return signal to acknowledge their presence.

Upon detecting the presence of a device within network range the portable device transmits a request to the remote device for an inventory of audio files held on the remote device. The remote device replies with an inventory list of audio files which are temporarily stored in the memory of the portable device. The portable device then compares its own inventory with the inventory supplied by the remote device. If audio files are identified on the remote device that are not present on the portable device then it transmits a request to the remote device to transmit a copy of the new data files to the portable device.

Upon receiving the request to transmit data to the portable device, the remote device transmits the file(s) to the portable device across the wireless network. These files are stored in the memory of the portable device and the inventory on the portable device is updated accordingly.

It will therefore be appreciated that a simple synchronisation between the portable device and the remote device is achieved whereby data files on the remote device are copied to the portable device automatically whenever it is within wireless communication range. This is a considerable improvement over the prior art in which the user needs both to constantly check the contents of the portable device and make appropriate updates when new music is purchased.

In an alternative, the remote device may take the role of deciding which data files are to be transmitted to the portable device. In this case, the remote device may perform the step of comparing its own inventory with the inventory transmitted by the portable device. Subsequent to this comparison the remote device may itself determine which new items of data are to be transmitted to the portable device. Again, this synchronisation may take place automatically whenever the portable device is brought into range of the remote device.

1. A network comprising a first and a second audio data storage device, each of said devices comprising:
an area of memory in which at least one audio data file is stored,
a file selection means adapted to permit a user to select at least one of said at least one audio data file, and
a data processor adapted to access said at least one selected file from said area of memory to generate an audio signal;
wherein said first device is adapted to communicate across said network to said second device such that each of said at least one audio data files stored in said area of memory of said first device which are not present in said area of memory of said second device are automatically copied to said area of memory of said second device.

2. The network of claim 1 wherein said copying of data is initiated automatically whenever one of said first and second devices detects a presence of an other of said first and second devices in said network.

3. The network of claim 1 wherein at least one of said first and second devices comprises a portable music player.

4. The network of claim 3 wherein at least one of said first and second devices comprises any one of: a personal computer, a mini-disc player, an MP3 player, and a compact disk player.

5. The network of claim 4 wherein said first device comprises a compact disk player adapted to store in said area of memory audio data files corresponding to audio data stored on a compact disk played on said first device.

6. The network of claim 1 wherein said first device includes a transmission means which, in use, transmits an identity signal across said network, and said second devices also includes a transmission means which, in use, issues an acknowledgement signal in response to detection of said identifying signal.

7. The network of claim 1 wherein said first device includes an inventory generation means which, in use, generates an inventory of said audio data files stored in said area of memory of said first device.

8. The network of claim 6 wherein said first device includes an inventory generation means which, in use, generates an inventory of said audio data files stored in said area of memory of said first device.

9. The network of claim 8 wherein said first device, when issuing said identifying signal, transmits said inventory as part of said identifying signal to said second device.

10. The network of claim 6 wherein said second device includes an inventory generation means which, in use, generates an inventory of said audio data files stored in said area of memory of said second device.

11. The network of claim 10 wherein said inventory is transmitted as part of said acknowledging signal.

12. The network of any claim 8 wherein, in use and upon receiving said inventory, said second device compares said received inventory with said inventory of said second device.

13. The network of claim 12 wherein said other of said second device generates an update inventory which comprises a list of said audio data files stored in said area of memory of said first device that are not present on said second device.

14. The network of claim 1 wherein each of said first and second devices in said network includes a wireless network connection for communication with an other of said first and second devices.

15. The network of claim 1 wherein at least one of said first and second devices includes reproduction means which, in use, reproduces audibly audio information stored in said audio data files.

16. The network of claim 1 wherein copying of said audio data files occurs automatically with no user interaction.

17. An audio device configured to operate as one of said first and second devices within a network according to claim 1.

18. The audio device of claim 16 which comprises a portable audio device.

19. A data carrier which includes a computer programme which when running on a processor of a device causes said device to operate as one of said first and second devices within a network according to claim 1.

20. A method of operating a computer system comprising at least a first and a second audio data storage device connected to form a network, said method comprising:
storing one or more audio files in a memory of at least one of said first and second devices; causing said first device to communicate across said network to said second device;
comparing said audio data files stored in said first device with said audio data files stored in said second device; and
automatically copying said audio data files which are stored in said first device and which are not stored in said second device across to said second device.

21. A method according to claim 20 which further comprises causing said first device to access an inventory of audio data files stored in said second device across said network and compare said inventory with a corresponding inventory of audio data files stored in said first device.

22. A method according to claim 21 wherein said first device transmits an inventory of its stored audio data files to said second device which subsequently compares said transmitted inventory with a corresponding inventory of its audio data files to identify audio data files stored in said first device that are not stored in said second device, and said second device subsequently transmitting to said first device across said network a request list of audio data files which are stored in said first device but not in said second device.

23. The method of claim 20 which further comprises the step of preventing automatic transfer of at least one of said audio data files if said automatic transfer is illegal.

24. The method of claim 23 wherein at least one of said audio data files includes a rights identifier, or indicates a location of a rights identifier, and at least one of each of said first and second devices transmitting data, and each of said first and second devices receiving data, checks said rights identifier to determine if a transfer is permitted.

25. The method of claim 23 which further comprises issuing a warning in an event that a user of at least one of said first and second devices attempts to copy data which cannot legally be copied.

26. A portable audio data storage device comprising:
an area of memory in which at least one audio data file is stored;
a file selection means adapted to permit a user to select at least one of said at least one audio data file; and
a data processor adapted to access said at least one selected file from said area of memory to generate an audio signal;
wherein said device is adapted to communicate to at least one other device across a network such said at least one audio data file stored in a memory of said at least one other device on said network that is not present on said audio data storage device is automatically copied to said area of memory of said audio data storage device.

27. The device of claim 26 wherein said audio data storage device is further adapted to copy across said network audio data files which are not stored in said memory of said at least one other device to said memory of said at least one other device.

28. The device of claim 26 wherein at least one of said at least one other devices is a Personal computer.

29. The device of claim 26 wherein said at least one audio data file is an encoded music track.

30. The device of claim 26 wherein a plurality of audio data files are stored in said area of memory of said device, said plurality of audio data files forming a music collection.

31. The device of claim 26 wherein said device is an MP3 player.

32. The device of claim 26 wherein said network is a wireless network and said device further comprises a wireless network transceiver.

33. The device of claim 32 wherein said wireless network is a Bluetooth network.

34. The device of claim 26 wherein said device comprises means for detecting said at least one other device which, in use, causes said audio storage device to perform copying only when at least one other device is present on said network.
